(19) United States
(12) Patent Application Publication
(10) Pub. No.: US 2016/0279012 A1
(43) Pub. Date: Sep. 29, 2016

(54) Apparatus and Method for Rehabilitating a Lower Leg Muscle

(71) Applicant: MARCO ANTONIO HURTADO, PEMBROKE PINES, FL (US)

(72) Inventor: MARCO ANTONIO HURTADO, PEMBROKE PINES, FL (US)

(21) Appl. No.: 14/666,680

(22) Filed: Mar. 24, 2015

(51) Int. Cl. A61H 1/02; A63B 23/10; A63B 23/08

(52) U.S. Cl. CPC A61H 1/0266; A63B 23/08; A63B 23/10; A63B 2208/03

(57) ABSTRACT

An apparatus and method for rehabilitating a lower leg muscle provides therapy for the lower leg muscle by simultaneously stretching the lower leg muscle and soaking the lower leg muscle in a therapeutic solution. This dual action therapy results in treatment of calf strains and/or Achilles tendon tears and the like. The apparatus includes a lower leg stretching component and a therapeutic soaking component. A synergy is created between the two components that addresses different anatomical considerations for the lower leg. Both the stretching and soaking components are performed inside a container. The stretching component includes a plate on which the foot rests. The plate pivots on a fulcrum. A strap passes around the plate and is pulled at the front end to stretch the lower leg muscle. The leg muscle provides resistance to the pulling action. A therapeutic solution fills the container, such that the stretching and soaking are performed simultaneously.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to an apparatus and method for rehabilitating a lower leg muscle by stretching the lower leg muscle while simultaneously soaking the lower leg muscle in a therapeutic solution and quantifying the therapy.

The inventor often performed physical activities, such as exercise and physical labor. The inventor witnessed and experienced leg cramps and other discomforts in the calf and/or Achilles tendon area of the lower leg before and after these physical exertions. The inventor noticed that often, the lower leg muscles would tighten up, swelling occurred, skin ailments appeared, and blood circulation problems occurred in the lower leg extremities.

The inventor performed some medical research and discovered that simple calf and/or Achilles tendon stretching exercises were effective for softening up the muscle tissue. This was especially recommended before and after physical performances, such as athletics or labor. The inventor also learned that soaking the lower leg in a Magnesium Sulfate and hot water solution was effective for resolving many of these ailments. The inventor started using these therapies individually and received some relief.

However, the inventor recognized a problem in which only one type of therapy could be utilized on the leg muscle at any one time. For example, the inventor could not stretch and soak the lower leg at the same time. This limitation prevented the leg muscle from benefiting from the various therapies known in the art.

Through additional research, the inventor learned that a bucket could be large enough to retain the therapeutic solution and also hold a pivoting mechanism. The pivoting mechanism was a simple machine consisting of a plate that pivoted on a fulcrum inside the container. A simple rubber strap could also be used while sitting adjacent to the bucket for pulling on the front end of the plate and foot.

This worked well for a time. However, the inventor realized that the stretching therapy was not very quantifiable. The inventor did not know if improvements in lower leg flexibility were occurring. The inventor recognized that a measuring tool would be needed to indicate how much the lower leg was stretching. In this manner, progress of the stretching therapy could be noted.

After performing some research on measuring tools the inventor realized that a disc could be attached at the fulcrum. The disc rotated coplanar to the plate. The disc also had incremental measuring points, including a reference point. The disc was measuring a distance traveled by the front end of the plate relative to a base of the bucket. In this manner, the inclination of the foot/ankle was measurable and measurement provided the inventor with an indication of the flexibility of the lower leg muscle.

For the foregoing reasons, there is a lower leg muscle therapy apparatus and method that simultaneously stretched and soaks the lower leg muscle.

Muscle rehabilitation systems have been utilized in the past; yet none with the present delivery expediting characteristics of the present invention. See U.S. Pat. Nos. 6,267,738; 8,615,301; and 20120070507.

For the foregoing reasons, there is an apparatus and method that provides a simple, yet effective rehabilitation and therapy for the lower leg muscle by stretching the lower leg muscle and then measuring the amount of the stretch, while simultaneously soaking the lower leg muscle in a therapeutic solution.

### SUMMARY

The present invention describes an apparatus and method for rehabilitating a lower leg muscle. The apparatus and method provides a simple, yet effective rehabilitation and therapy for the lower leg muscle by stretching the lower leg muscle while simultaneously soaking the lower leg muscle in a therapeutic solution to provide the desired relief. Further, the stretching capacity of the apparatus is measurable so as to quantify the rehabilitation and therapy. This dual action therapy may result in treatment of calf and/or Achilles tendon strains, soothing of lower leg muscles, reduction in swelling at the lower leg, reduction in blood clots, detoxification, and general enhanced physical fitness.

The apparatus and method includes a lower leg stretching component and a therapeutic soaking component. A synergy is created between the two different components that addresses different anatomical considerations for the lower leg muscle. The stretching component allows the user to controllably and safely stretch the calf and/or Achilles tendon muscle area by pulling back on a front region of the foot up to 90° through the use of a resilient strap that passes around the foot and has a pair of free ends for grasping.

Furthermore, the distance that the foot is pivotally displaced is measurable to help quantify the therapy. The therapeutic soaking component enables the lower leg muscle to be soaked in, and consequently absorb, a therapeutic solution. The therapeutic solution may include, without limitation, a Magnesium Sulfate and hot water composition. The stretching and soaking are performed simultaneously to achieve optimal therapeutic results.

In some embodiments, the apparatus may include a container that is configured to retain the therapeutic solution. The container is defined by a base, a sidewall, an opening, and a cavity. In one embodiment, the container is a bucket that is sized and dimensioned to receive a foot. The stretching and soaking components are performed fully within the cavity of the container.

In some embodiments, the apparatus may further include a fulcrum. The fulcrum is defined by a pair of spaced-apart legs and an axle that extends between the legs. The fulcrum is disposed to position in the cavity of the container. The pair of legs from the fulcrum are disposed to position concentrically and fixedly on the base of the container. The pair of legs form a generally V-shape, with each leg having an axle hole passing through the junction of the V. The axle passes through the axle hole, extending equidistant between the legs.

In some embodiments, the apparatus may further include a generally elongated plate. The plate is defined by a first end, a second end, a top surface, and a bottom surface. The bottom surface of the plate is disposed to rest on the axle. Specifically, the plate rests equidistant between the first and second ends of the plate, such that the plate remains balanced on the axle.

The top surface of the plate is configured to receive a foot in an orientation, whereby the toes are proximal to the first end and the heel is proximal to the second end of the plate. Thus, both the plate and the foot pivot about the axle between a substantially horizontal position and a substantially vertical position.

In some embodiments, the apparatus may further include a pivot scale that quantifies the pivot by the foot. The pivot scale is disposed to join with the plate. In one embodiment, the pivot scale is a disc that attaches to a midpoint at the bottom surface of the plate, proximally to the axle. The pivot scale is marked in fractional increments of revolution from a reference point. The pivot scale measures a distance traveled by the first end of the plate relative to the base of the container. The fractional increments, which may include inches or centimeters, provide a quick reference that indicates the radial pivoting distance of the foot; and thus the amount of flexibility of the lower leg muscle.

In an alternative embodiment, a second tool for quantifying the amount of pivoting by the foot is a linear ruler that is disposed along the sidewall of the container. The linear ruler is marked in fractional increments from a linear reference point near the base of the container. Similar to the pivot scale, the linear ruler measures a distance traveled by the first end of the plate relative to the base of the container.

In some embodiments, the apparatus may further include a strap. The strap is defined by a generally resilient body and a pair of free ends. The body of the strap is disposed to pass around the bottom surface of the plate near the first end. The pair of free ends enable the body of the strap to be pulled for pivotally articulating the plate between the horizontal and vertical positions.

Specifically, the pair of free ends of the strap are configured to enable pulling the first end of the plate against a resistance, such as the lower leg muscle. In one embodiment the pair of free ends are pulled until the resistance from the lower leg muscle reaches a desired amount, at which point the strap is released to relax the lower leg muscle. It is this repetitive pulling and relaxing that provides the stretching therapy. The stretching, coupled with the simultaneous soaking in the therapeutic solution, further enhances the therapy and rehabilitation of the lower leg muscle.

In one embodiment, the method for rehabilitating a lower leg muscle by stretching and soaking in a therapeutic solution may include the steps of: filling a container with a therapeutic solution; positioning a foot in a cavity of the container, whereby a lower leg muscle is immersed in the therapeutic solution; pressing a foot on a top surface of a generally elongated plate; passing a strap around a first end of the plate; pulling a pair of free ends of the strap against a resistant force, whereby the resistant force is the lower leg muscle; pivoting the plate about a fulcrum between a substantially horizontal position and a substantially vertical position; and measuring a distance traveled by the first end of the plate relative to a base of the container.

One objective of the present invention is to provide therapy and rehabilitation to a lower leg muscle.

Another objective is to treat calf and/or Achilles tendon strains or tears, soothing of lower leg muscles, reduction in swelling at the lower leg, reduction in blood clots, and detoxify the lower leg muscle.

Another objective of the present invention is to stretch the lower leg muscle and simultaneously soak the lower leg muscle in a therapeutic solution.

Another objective of the present invention is to measure the radial motion of the foot during stretching so as to quantify the lower leg muscle therapy.

Yet another objective of the present invention is to provide a resilient strap that passes around the first end of the plate and can be pulled against a resistance form the lower leg muscle.

Yet another objective is to provide an inexpensive to manufacture lower leg therapy apparatus.

### DRAWINGS

These and other features, aspects, and advantages of the present invention will become better understood with regard to the following description, appended claims, and drawings where:

FIG. 1 is a side view of an exemplary apparatus for stretching a lower leg muscle with the lower leg immersed in a container and stretching with a strap;

FIG. 2 is a sectioned side view of the apparatus for stretching a lower leg muscle with a plate in a relaxed position;

FIG. 3 is a sectioned side view of the apparatus for stretching a lower leg muscle with a plate in a stretch position;

FIGS. 4A and 4B are views of the apparatus in a relaxed position, where FIG. 4A is a top view and FIG. 4B is an elevated side view;

FIGS. 5A and 5B are views of the apparatus being pulled to a stretch position, where FIG. 5A is a top view and FIG. 5B is an elevated side view;

FIGS. 6A and 6B are views of the apparatus in a stretched position, where FIG. 6A is a top view and FIG. 6B is an elevated side view;

FIGS. 7A and 7B are views of a fulcrum and a plate, where FIG. 7A is a perspective view and FIG. 7B is a close-up view of the fulcrum and a pivot scale; and

FIG. 8 is a flowchart diagram of an exemplary method for rehabilitating a lower leg muscle by stretching and soaking.

### DESCRIPTION

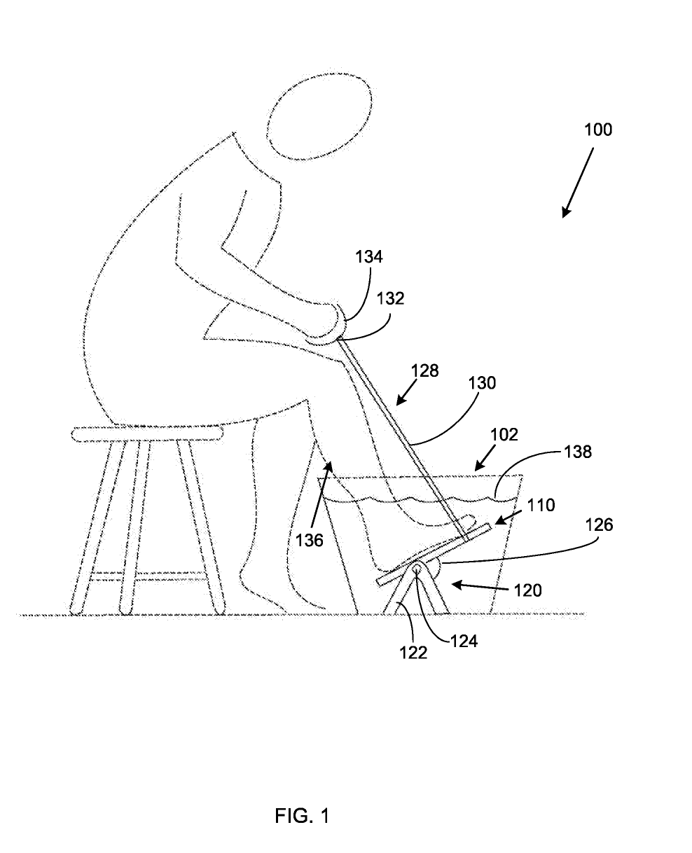

The present invention, referenced in FIGS. 1-8, is directed to an apparatus 100 and method 200 for stretching and rehabilitating a lower leg muscle 136. As illustrated in FIG. 1, the apparatus 100 provides a simple, yet effective rehabilitation and therapy for the lower leg muscle 136 by simultaneously stretching the lower leg muscle 136, while simultaneously soaking the lower leg muscle 136 in a therapeutic solution 138 to provide the desired relief. Further, the stretching capacity of the apparatus 100 is measurable so as to quantify the rehabilitation and therapy. This dual action therapy may result in treatment of calf and/or Achilles tendon strains, soothing of leg muscles, reduction in swelling at the lower leg, reduction in blood clots, detoxification, and general enhanced physical fitness.

Those skilled in the art will recognize that calf and/or Achilles tendon stretches are effective for rehabilitating the relatively elastic, flexible lower leg muscles 136. For example, the stretching exercises soften the shock at the first point of impact during walking or running, such as the foot and ankle region. Calf and/or Achilles tendon stretches can also open the tight network of lower leg muscles 136 that sometimes seize up after overuse or other underlying factors. One exemplary calf and/or Achilles tendon stretching technique for assessing calf and/or Achilles tendon muscle flexibility is to apply gentle pressure to the forefoot with the leg out straight in front. In this exercise, there is a point where the resistance noticeably increases as the calf muscle and/or Achilles tendon begins to stretch. The apparatus 100 is efficacious for performing these stretching exercises, while also providing a quantitative measurement of the distance the foot has pivoted, and thereby the amount that the calf and/or Achilles tendon has been stretched.

Those skilled in the art will also recognize that there are effective therapeutic solutions 138 that can work effectively with the aforementioned lower leg stretching exercises. For example, Magnesium Sulfate (Epsom salt) has beneficial properties that can reduce muscle swelling, relax the nervous system, cure skin problems, sooth back pain and aching limbs, ease muscle strain, heal cuts, treat cold and congestion, and draw toxins from the body.

The magnesium and sulfate are both readily absorbed through the skin, making Epsom salt baths an easy and ideal way to enjoy the amazing health benefits. It is significant to note that Magnesium plays a number of roles in the body including regulating the activity of over 325 enzymes, reducing inflammation, helping muscle and nerve function and helping to prevent artery hardening. Furthermore, Sulfates help improve the absorption of nutrients, flush toxins and help ease migraine headaches. However, any number of therapeutic solvents may also be used in the present invention.

The apparatus 100 and method 200 includes both a lower leg stretching component and a therapeutic solution 138 soaking component. A synergy is created between the two different components that addresses different anatomical considerations for the lower leg muscle 136.

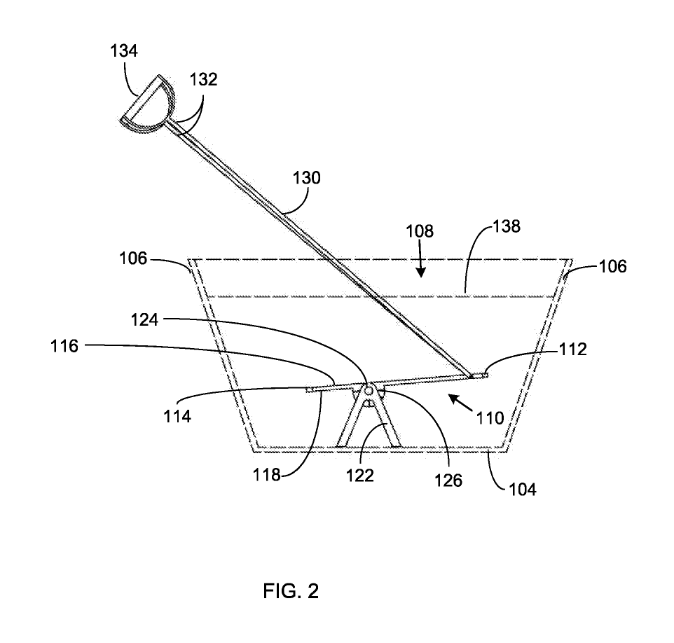

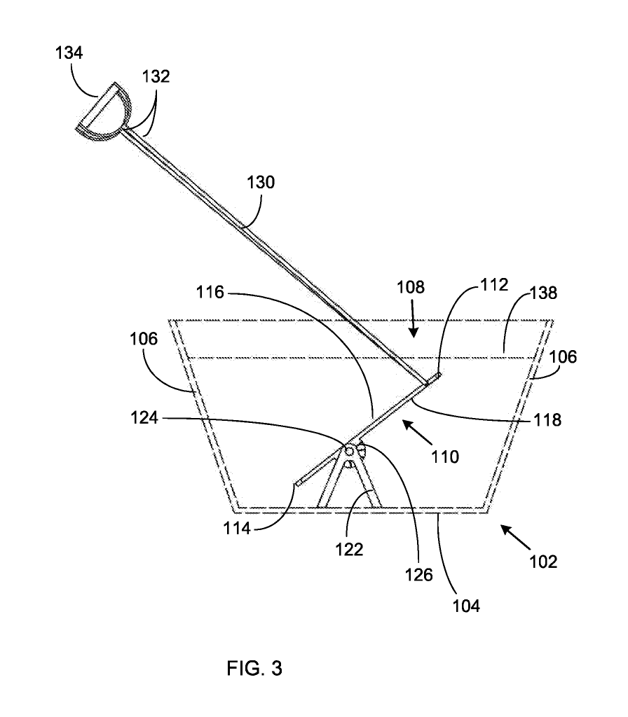

The stretching component allows the user to controllably and safely stretch the lower leg muscle 136 area by pulling back on a front region of the foot up to 90° through the use of a resilient strap 128 that passes around the foot and has a pair of free ends 132 for grasping. FIG. 2 illustrates the apparatus 100 relaxed in a natural position. FIG. 3 illustrates the apparatus 100 fully extended in a stretch position. The distance that the foot is pivotally displaced between the aforementioned extreme positions is measurable. These measurements help quantify the lower leg muscle therapy for recording progress during muscle therapy.

Additionally, the therapeutic soaking component enables the lower leg muscle 136 to be soaked in, and consequently absorb, a therapeutic solution 138. The therapeutic solution 138 may include, without limitation, a Magnesium Sulfate and hot water composition, ice water, herbal liquids, gels, and general hydrotherapy. The stretching and soaking functions are performed simultaneously in a container 102 to achieve optimal therapeutic results.

As illustrated in FIGS. 3A and 3B, the apparatus 100 may include a container 102 that is configured to retain the therapeutic solution 138. The container 102 is defined by a base 104, a sidewall 106, an opening 108, and a cavity. In one embodiment, the container 102 is a bucket that is sized and dimensioned to receive a foot. The stretching and soaking functions are performed fully within the cavity of the container 102. The container 102 may include, without limitation, a bucket, a tub, and a therapy well. Suitable materials for the container 102 may include, without limitation, a rigid polymer, metal, wood, and fiberglass.

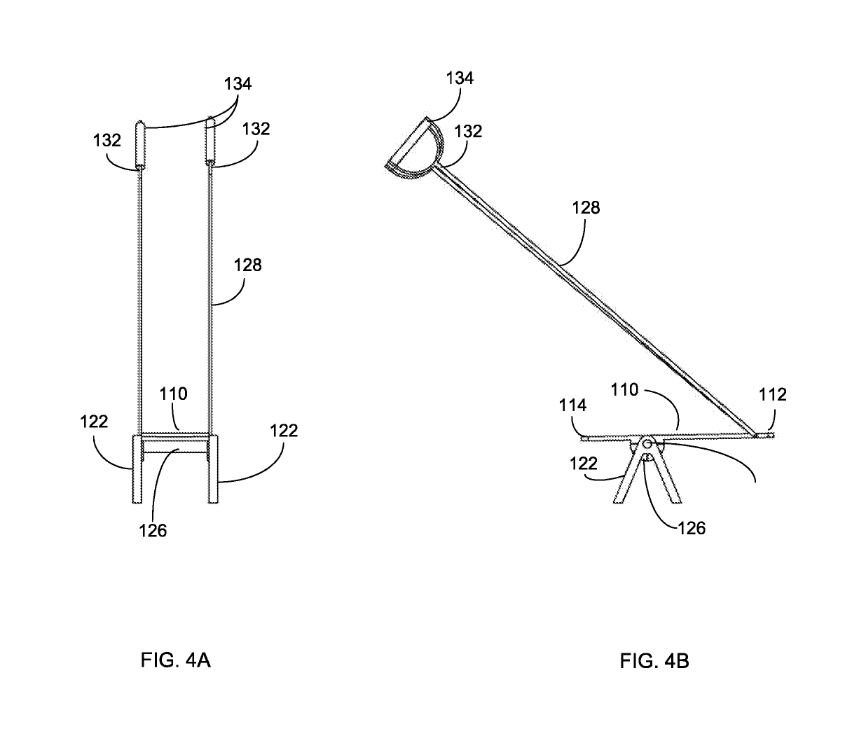

FIG. 4A shows a fulcrum 120 that forms the mechanism that enables the stretching exercises through a repetitive pivoting motion. The fulcrum 120 concentrically and fixedly rests in the cavity of the container 102. The fulcrum 120 is defined by a pair of spaced-apart legs 122 and an axle 124 that extends between the legs 122. The pair of legs 122 are disposed to position concentrically and fixedly on the base 104 of the container 102. In one embodiment, the legs 122 are bolted or welded to the base 104 of the container 102. The legs 122 form a generally V-shape, with each leg having an axle hole passing through the junction of the V. The axle 124 passes through the axle hole, extending equidistant between the legs 122. However, in one alternative embodiment, the axle 124 passes through opposite ends of the sidewall 106, extending across the cavity and forming a pivot point without the use of the legs 122.

As shown in FIG. 4B, the apparatus 100 may further include a generally elongated plate 110. The plate 110 is defined by a first end 112, a second end 114, a top surface 116, and a bottom surface 118. In one embodiment, the plate 110 is rectangular and substantially rigid. The bottom surface 118 of the plate 110 is disposed to rest on the axle 124. Specifically, the plate 110 rests equidistant between the first and second ends 112, 114 of the plate 110, such that the plate 110 remains balanced on the axle 124.

The top surface 116 of the plate 110 is configured to receive a foot in an orientation, such that the toes are proximal to the first end 112 and the heel is proximal to the second end 114 of the plate 110. Thus, both the plate 110 and the foot pivot about the axle 124 between a substantially relaxed horizontal position and a stretching vertical position.

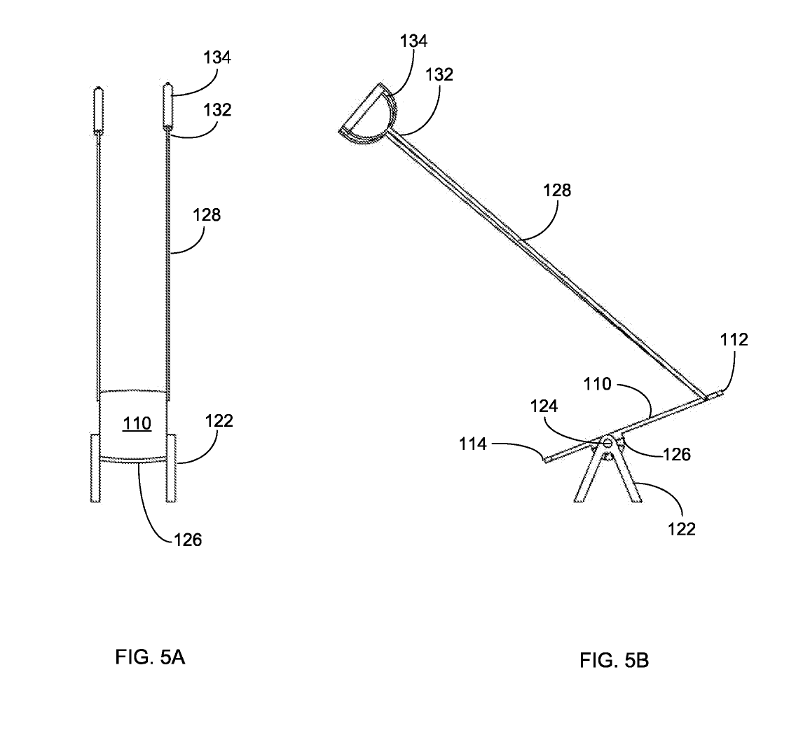

Looking at FIGS. 5A and 5B, the apparatus 100 may further include a pivot scale 126 that quantifies the pivoting distance of the foot. The pivot scale 126 is disposed to join with the plate 110. In one embodiment, the pivot scale 126 is a marked disc that attaches to a midpoint at the bottom surface 118 of the plate 110, proximally to the axle 124. The pivot scale 126 is marked in fractional increments of revolution from a reference point. The pivot scale 126 measures a distance traveled by the first end 112 of the plate 110 relative to the base 104 of the container 102. In this manner, the inclination of the foot/ankle is measurable. This provides an indication of flexibility of the lower leg muscle 136. The fractional increments, which may include inches or centimeters, provide a quick reference that indicates the radial pivoting distance of the foot; and thus the amount of flexibility of the lower leg muscle 136. In one alternative embodiment, the pivot scale 126 includes a clicker that generates incremental clicking sounds during every fractional increment of movement.

In an alternative embodiment, a second tool for quantifying the amount of pivoting by the foot may include a linear ruler (not shown) that is disposed along the length of the sidewall 106 inside the container 102. The linear ruler is marked in fractional increments from a linear reference point near the base 104 of the container 102. Similar to the pivot scale 126, the linear ruler measures a distance traveled by the first end 112 of the plate 110 relative to the base 104 of the container 102.

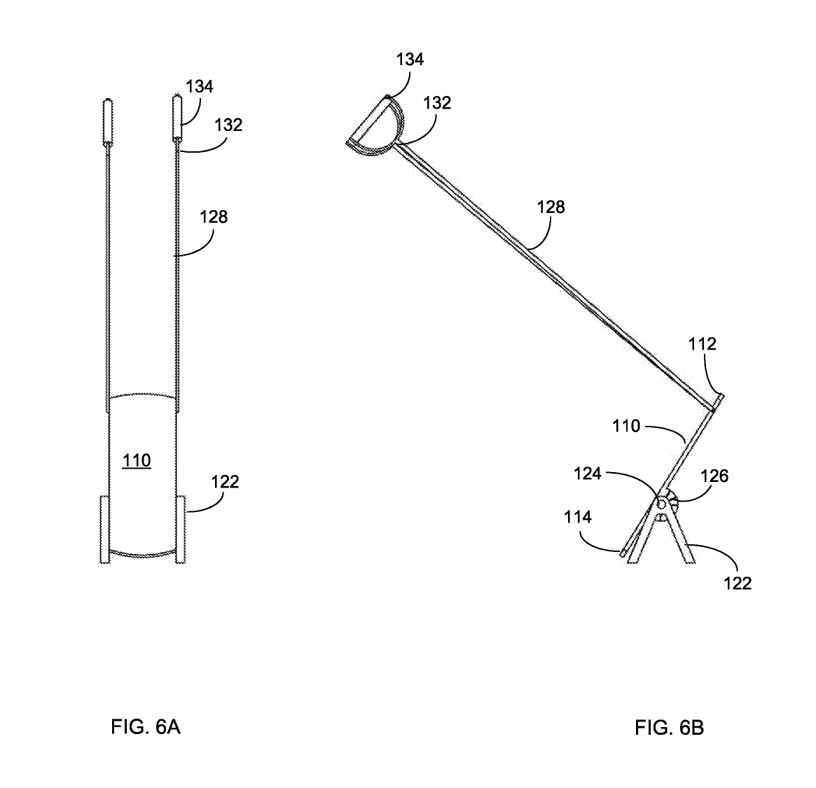

Looking at FIGS. 6A and 6B, the apparatus 100 may further include a strap 128. The strap 128 is defined by a generally resilient body 130 and a pair of free ends 132. Each free end 132 may have a handle 134 for enabling gripping and manipulation of the strap 128. In one possible embodiment, the strap 128 is a rubber band that is sufficiently long enough to extend between the plate 110 and a user sitting adjacent to the container 102. The body 130 of the strap 128 is disposed to pass around the bottom surface 118 of the plate 110 near the first end 112.

In some embodiments, the body 130 may easily detach from the bottom surface 118 of the plate 110. However, in other embodiments, the body 130 of the strap 128 remains fixedly attached to the bottom surface 118 of the plate 110. The pair of free ends 132 enable pulling and releasing the body 130 of the strap 128 to pivotally articulate the plate 110 between the horizontal and vertical positions.

Specifically, the pair of free ends 132 of the strap 128 are configured to enable pulling the first end 112 of the plate 110 against a resistance, such as the lower leg muscle 136. In one embodiment the pair of free ends 132 are pulled until the resistance from the lower leg muscle 136 reaches a desired amount, at which point the strap 128 is released to relax the lower leg muscle 136. It is this repetitive pulling and relaxing that provides the stretching therapy. The stretching, coupled with the simultaneous soaking in the therapeutic solution 138, further enhances the therapy and rehabilitation of the lower leg muscle 136.

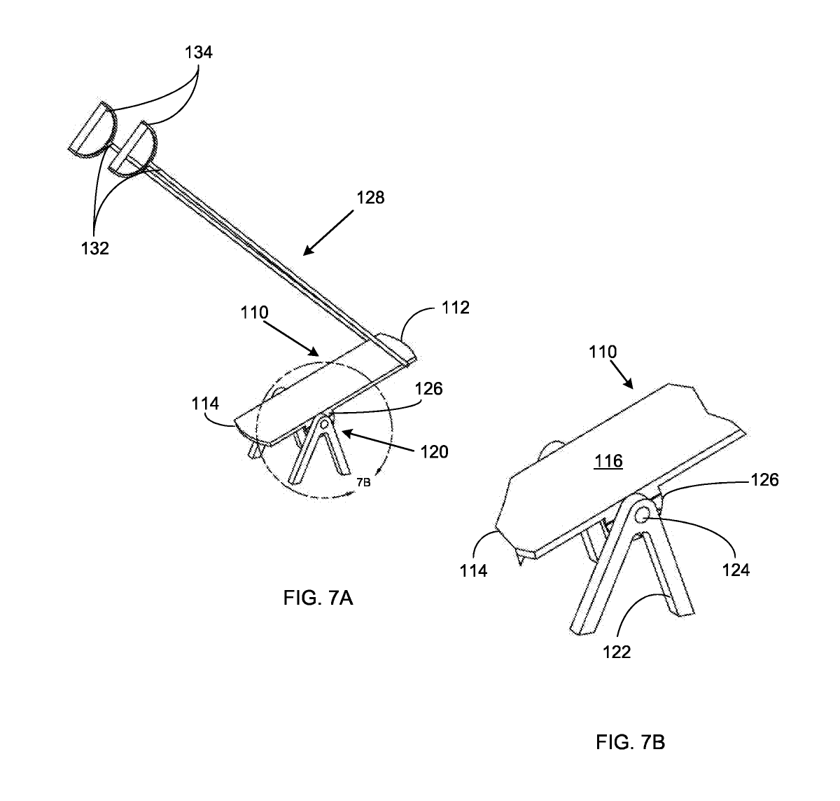

The pivoting mechanism used for stretching the lower leg muscle 136 relies on the fulcrum 120 shown in FIG. 7A. The fulcrum 120 is a standard fulcrum 120 known in the art. The axle 124 provides the pivot point for the plate 110, which in turn, supports the foot. FIG. 7B illustrates a close-up view of the pivot scale 126. As described above, the pivot scale 126 measures a distance traveled by the first end 112 of the plate 110 relative to the base 104 of the container 102. In this manner, the inclination of the foot/ankle is measurable. This measurement provides an indication of flexibility of the lower leg muscle 136.

In some embodiments, the apparatus 100 may include alternative embodiments. For example, there may be two plates 110 inside the container 102, such that both feet can be stretched simultaneously, and the container 102 may have a heater for heating the therapeutic solution 138. The container 102 may also be expanded in size, such that the whole leg and the back are stretched and soaked as described above.

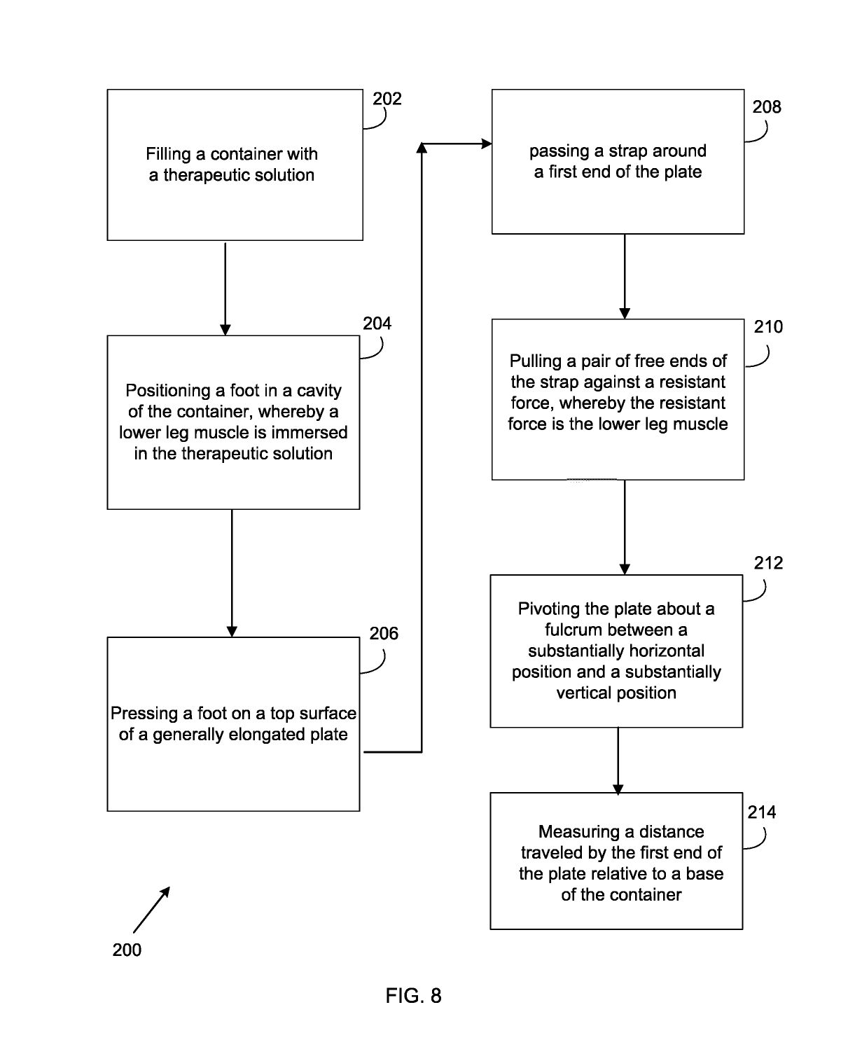

FIG. 8 illustrates a flowchart diagram of an exemplary method 200 for rehabilitating a lower leg muscle 136 by stretching and soaking in a therapeutic solution 138. The method 200 provides rehabilitation and therapy for the lower leg muscle 136 by simultaneously stretching and soaking the lower leg muscle 136 in the therapeutic solution 138. This dual action therapy results in treatment of calf strains and/or Achilles tendon tears and the like. The method 200 may include an initial Step 202 of filling a container 102 with a therapeutic solution 138. The container 102 is configured to retain the therapeutic solution 138. The container 102 is defined by a base 104, a sidewall 106, an opening 108, and a cavity. Those skilled in the art will also recognize that there are effective therapeutic solutions 138 that can work effectively with the aforementioned stretching exercises. For example, Magnesium Sulfate (Epsom salt) has beneficial properties that can reduce muscle swelling, relax the nervous system, cure skin problems, sooth back pain and aching limbs, ease muscle strain, heal cuts, treat cold and congestion, and draw toxins from the body.

The method 200 may further comprise a Step 204 of positioning a foot in a cavity of the container 102, whereby a lower leg muscle 136 is immersed in the therapeutic solution 138. In one embodiment, the container 102 is a bucket that is sized and dimensioned to receive a foot.

A Step 206 includes pressing a foot on a top surface 116 of a generally elongated plate 110. The plate 110 is defined by a first end 112, a second end 114, a top surface 116, and a bottom surface 118. In one embodiment, the plate 110 is rectangular and substantially rigid. The top surface 116 of the plate 110 is configured to receive a foot in an orientation, such that the toes are proximal to the first end 112 and the heel is proximal to the second end 114 of the plate 110.

In some embodiments, a Step 208 comprises passing a strap 128 around a first end 112 of the plate 110. The strap 128 is defined by a generally resilient body 130 and a pair of free ends 132. Each free end 132 may have a handle 134 for enabling gripping and manipulation of the strap 128. The body 130 of the strap 128 is disposed to pass around the bottom surface 118 of the plate 110 near the first end 112.

A Step 210 includes pulling a pair of free ends 132 of the strap 128 against a resistant force, whereby the resistant force is the lower leg muscle 136. The free ends 132 of the strap 128 are configured to enable pulling the first end 112 of the plate 110 against a resistance, such as the lower leg muscle 136.

In some embodiments, a Step 212 may include pivoting the plate 110 about a fulcrum 120 between a substantially horizontal position and a substantially vertical position. In one embodiment the pair of free ends 132 are pulled until the resistance from the lower leg muscle 136 reaches a desired amount, at which point the strap 128 is released to relax the lower leg muscle 136.

A final Step 214 includes measuring a distance traveled by the first end 112 of the plate 110 relative to a base 104 of the container 102. The pivot scale 126 measures a distance traveled by the first end 112 of the plate 110 relative to the base 104 of the container 102. In this manner, the inclination of the foot/ankle is measurable. This measurement provides an indication of flexibility of the lower leg muscle 136.

While the inventor's above description contains many specificities, these should not be construed as limitations on the scope, but rather as an exemplification of several preferred embodiments thereof. Many other variations are possible. For example, there may be two plates 110 inside the container 102, such that both feet can be stretched simultaneously, and the container 102 may have a heater for heating the therapeutic solution 138. Accordingly, the scope should be determined not by the embodiments illustrated, but by the appended claims and their legal equivalents.

What is claimed is:

1. An apparatus for rehabilitating a lower leg muscle by stretching and soaking, the apparatus comprising:
a container, the container defined by a base, a sidewall, an opening, and a cavity;
a fulcrum, the fulcrum defined by a pair of spaced-apart legs and an axle that extends between the pair of spaced-apart legs, the fulcrum disposed to position generally concentrically in the cavity of the container;
a generally elongated plate, the plate defined by a first end, a second end, a top surface, and a bottom surface, the bottom surface of the plate is disposed to rest on the axle,
whereby the plate pivots about the axle between a substantially horizontal position and a substantially vertical position;
a pivot scale, the pivot scale disposed to join with the plate, the pivot scale marked in fractional increments of revolution from a reference point, whereby the pivot scale measures a distance traveled by the first end of the plate relative to the base of the container; and
a strap, the strap defined by a generally resilient body and a pair of free ends, the body of the strap disposed to pass around the bottom surface of the plate near the first end, whereby the pair of free ends enable the body of the strap to pivotally articulate the plate between the horizontal and vertical positions.

2. The apparatus of claim 1, wherein the container is a bucket.

3. The apparatus of claim 1, wherein the container is configured to enable retention of a therapeutic solution.

4. The apparatus of claim 3, wherein the therapeutic solution is Magnesium Sulfate and hot water.

5. The apparatus of claim 1, wherein the pair of spaced-apart legs are disposed to position concentrically and fixedly on the base of the container.

6. The apparatus of claim 1, wherein the pair of spaced-apart legs form a V-shape having an axle opening.

7. The apparatus of claim 1, wherein the axle passes through the axle hole of each leg.

8. The apparatus of claim 1, wherein the plate rests on the axle, equidistant between the first and second ends.

9. The apparatus of claim 1, wherein the plate is configured to enable a foot to rest on the top surface, the foot being oriented such that the toes are proximal to the first end and the heel is proximal to the second end of the plate.

10. The apparatus of claim 1, wherein the pivot scale is a radial disc disposed on the bottom surface of the plate.

11. The apparatus of claim 1, wherein the fractional increments are inches or centimeters.

12. The apparatus of claim 1, wherein the sidewall of the container has a linear ruler, the linear ruler marked in fractional increments from a linear reference point, wherein the linear ruler measures a distance traveled by the first end of the plate relative to the base of the container.

13. The apparatus of claim 1, wherein the strap has a rubber composition.

14. The apparatus of claim 1, wherein the pair of free ends have handles.

15. The apparatus of claim 1, wherein the pair of free ends of the strap are configured to enable pulling the first end of the plate against a resistance.

16. The apparatus of claim 15, wherein the resistant force is the lower leg muscle.

17. An apparatus for rehabilitating a lower leg muscle by stretching and soaking, the apparatus comprising:
a container, the container defined by a base, a sidewall, an opening, and a cavity, the container configured to enable retention of a therapeutic solution;
a fulcrum, the fulcrum defined by a pair of spaced-apart legs and an axle that extends between the pair of spaced-apart legs, the fulcrum disposed to position generally concentrically in the cavity of the container;
a generally elongated plate, the plate defined by a first end, a second end, a top surface, and a bottom surface, the bottom surface of the plate is disposed to rest on the axle, the plate configured to enable a foot to rest on the top surface, whereby the foot is oriented such that the toes are proximal to the first end and the heel is proximal to the second end of the plate, whereby the plate pivots about the axle between a substantially horizontal position and a substantially vertical position;
a pivot scale, the pivot scale disposed to join with the plate, the pivot scale marked in fractional increments of revolution from a reference point, whereby the pivot scale measures a distance traveled by the first end of the plate relative to the base of the container;
a linear ruler, the linear ruler disposed along the sidewall of the container, the linear ruler marked in fractional increments from a linear reference point, wherein the linear ruler measures a distance traveled by the first end of the plate relative to the base of the container; and
a strap, the strap defined by a generally resilient body and a pair of free ends, the body of the strap disposed to pass around the bottom surface of the plate near the first end, whereby the pair of free ends enable the body of the strap to pivotally articulate the plate between the horizontal and vertical positions.

18. The apparatus of claim 17, wherein the therapeutic solution is Magnesium Sulfate and hot water.

19. The apparatus of claim 17, wherein the pair of free ends of the strap are configured to enable pulling the first end of the plate against a resistance.

20. A method for rehabilitating a lower leg muscle by stretching and soaking in a therapeutic solution, the method comprising:
filling a container with a therapeutic solution;
positioning a foot in a cavity of the container, whereby a lower leg muscle is immersed in the therapeutic solution;
pressing a foot on a top surface of a generally elongated plate;
passing a strap around a first end of the plate;
pulling a pair of free ends of the strap against a resistant force, whereby the resistant force is the lower leg muscle;
pivoting the plate about a fulcrum between a substantially horizontal position and a substantially vertical position; and
measuring a distance traveled by the first end of the plate relative to a base of the container.
